(19) United States
(12) Patent Application Publication
(10) Pub. No.: US 2004/0082337 A1
(43) Pub. Date: Apr. 29, 2004

(54) Method and a system for managing the changing of resources in a communications network

(75) Inventors: Didier Lacroix, Chateaufort (FR); Francois Duhamel, Montmorency (FR); Antoine Soulie, Paris (FR)

Correspondence Address: SUGHRUE MION, PLLC, Suite 800, 2100 Pennsylvania Avenue, N.W., Washington, DC, 20037-3213, US

(73) Assignee: EVOLIUM S.A.S.

(21) Appl. No.: 10/686,574

(22) Filed: Oct. 17, 2003

(30) Foreign Application Priority Data
Oct. 21, 2002 (FR) 02 13 055

(51) Int. Cl. H04Q 7/20; H04B 7/00

(52) U.S. Cl. 455/450; 455/509

(57) ABSTRACT

A system (D) is dedicated to managing the changing of channels between a network controller (BSCn) and at least one network equipment (MS-i) in a communications network. The system includes management means (M) that are adapted, when a connection for sending and/or receiving data has been set up on a first channel (C1) between the network controller (BSCn) and the network equipment (MS-i), to instruct the network controller (BSCn), firstly, to send the network equipment (MS-i) a message on the first channel (C1) instructing it to continue the connection on a second channel (C2) and to maintain the first channel (C1) until it receives data and/or acknowledgments of data from the equipment (MS-i) on the second channel (C2), and, secondly, to release the resources associated with the first channel (C1) on receiving data and/or acknowledgments of data on the second channel (C2).

The field of the invention is that of communications networks, and in particular that of managing the changing of resources or logical channels supporting connections between a communications network and network equipments, also known as entities, subject to a non-zero transmission error rate.

Communications networks, and in particular cellular networks, generally include a radio access network comprising nodes, also known as radio network controllers (RNC) or base station controllers (BSC), for managing the allocation of resources and logical channels, such as channel codes and radio connection channels, enabling the network equipments to set up connections to its local network, which are also known as channels. The connections can support sending of data in the direction from the network to the equipments, which is known as the downlink direction, or in the direction from the equipments to the network, which is known as the uplink direction.

The person skilled in the art is aware that the capacity and efficiency of communications networks, especially cellular networks, can be significantly increased if the resources allocated to the network equipments can be changed dynamically during the connection to the radio access network, with minimum interruption of traffic and a minimum period of overlapping use of the old and new resources or logical channels.

The access network controllers (nodes) are therefore generally adapted to initiate a procedure for changing the resources or channels allocated to the network equipments that they manage whenever necessary. The procedure includes, firstly, a request to allocate resources (for a new channel, for example), followed by interrupting the data traffic on the old channel and sending a message to the network equipment concerned on the old channel, this message instructing it to change channel. When the network equipment has acknowledged receipt of the message on the old channel, data traffic is sent to the network equipment on the new channel and the old channel is released and can be re-allocated. In some embodiments the network cannot send traffic on the new channel until the acknowledgment has been received on the old channel. However, if the acknowledgment is not received on the old channel, the network controller must send the message to the network equipment again, possibly several times, on the old channel and the new channel, as there is no way of knowing whether the network equipment is still connected to the old channel or has been connected to the new channel. In fact, all that the network controller knows is that the network equipment can receive only one channel at a time, either the old channel or the new channel.

Because of this procedure, and because of the inherent possibility of it failing because of the transmission error rate, the time for which traffic is interrupted can be very much longer than is necessary for the network equipment to change channel or resources. The average duration of overlapping use of the old and new resources slows down the general procedure for managing all resources of the network, because the old resources cannot be released until the procedure has been completed. Consequently, network capacities are reduced and the traffic load, which is related to the requirements of the network equipments, cannot be distributed optimally.

What is more, the above procedure takes account neither of the risk of failure of the resource change nor of any timing and/or capacity differences because of specific features of the old and new resources.

Thus an object of the invention is to remedy some or all of the above-mentioned drawbacks.

To this end, the invention proposes a method of managing the changing of resources or logical channels between a communications network and network equipments (for example mobile telephones, or more generally any type of data exchange terminal).

The method is characterized in that, in the event of setting up a connection between the network and at least one of the network equipments using a first or old channel or first or old resources, the network equipment is instructed, via the first channel, to continue the connection using a second or new channel or second or new resources and to maintain the first channel until it receives data and/or acknowledgments of data from said equipment on said second channel. The resources of the first channel are released once the first channel is no longer being used by the mobile station, i.e. once the network receives data and/or acknowledgments of data from the network equipment on the second channel.

If the equipment is sending uplink data to the network when the network instructs it to change channel, the network maintains the first channel until it receives data from the network equipment on the second channel.

If the network is sending downlink data to the equipment at the time the network instructs the equipment to change channel, the network continues to send data to the network equipment on the first and second channels or resources and interrupts the first channel when it receives acknowledgments of data from the network equipment on the second channel.

The procedure is exactly the same if the network is sending downlink and uplink data simultaneously at the time of the instruction to change channel. The network maintains the first channel and continues to send downlink data to the network equipment on the first and second channels or resources, and interrupts the first channel when it receives data or acknowledgments of data from the network equipment on the second channel.

As traffic is sent on the first and second channels, the network need not concern itself with when the network equipment changes channel, which may not be known accurately.

The message on the first channel is preferably repeated a chosen (and possibly predefined) number of times in accordance with a chosen time scheme, for example a periodic scheme. In a preferred embodiment, the number of repetitions is chosen as a function of a required success rate and/or as a function of an error rate on the channel or the resources used and measured in the network.

In another preferred embodiment, the repetition period on the first channel is chosen to prevent correlation between the error rates associated with two messages received consecutively.

Moreover, it is advantageous to determine a time period enabling the channel or resource change messages to reach the network equipment ahead of time by an amount at least equal to the time the network equipment needs to change channel, in order to defer the sending of data using the first and second channels or resources by an amount that is a function of that time. This kind of determination can also take into account the data bit rates and/or the data sending speeds of the first and second channels or resources.

The repetition of the message the chosen number of times can continue as long as no acknowledgments of data are received from the network equipment on the second channel. Alternatively, the repetition of the message can be accompanied by substantially simultaneous observation of the network to detect any change of behavior of the network equipment to which the message if sent. In this case, the detected change in the behavior of the network equipment can consist in the reception of data from the network equipment on the second channel or a variation in a parameter chosen from, in particular, a change of operating mode, a frequency, a position, or reception of an acknowledgment after polling.

The invention also proposes a system from managing changes of channels or resources between a node or network controller (such an RNC or a BSC, for example) and at least one network equipment within a communications network.

The system is characterized in that it includes management means adapted, in the event of setting up a connection for sending and/or receiving data between said network controller and said network equipment using a first channel or resources, to instruct said network controller, firstly, to send said network equipment a message on said first channel instructing it to continue said connection on a second channel and to maintain said first channel until it receives data and/or acknowledgments of data from said equipment on said second channel and, secondly, to release the resources associated with said first channel on receiving said data and/or said acknowledgments of data.

According to another feature of the invention, if data is being sent to the network equipment, the management means are adapted to instruct the network controller to continue sending data to that equipment on the first and second channels until it receives data and/or acknowledgments of data from the network equipment on the second channel.

The management system of the invention can have other, complementary features, such as the following features, separately and/or in combination:

management means adapted to repeat the message using the first channel or resources a chosen (and possibly predefined) number of times, in accordance with a chosen time scheme, for example a periodic scheme; in this case, the number of repetitions can be chosen (for example determined, for instance by means of a probability calculation) as a function of a required success rate and/or a measured error rate; moreover, the interval between two repetitions can be chosen to prevent correlation between the error rates associated with two consecutive messages;

management means adapted to determine a time period enabling the channel or resource change messages to reach the network equipment ahead of time by an amount at least equal to the time it needs to change channel or resources, and then, in the case of downlink data, to instruct the node or network controller to defer the sending of data using the first and second channels or resources by an amount that is a function of the aforementioned time, which can also be determined as a function of the data bit rates and/or data sending speeds of the first and second channels or resources;

management means adapted to repeat the message the chosen number of times until data acknowledgments are received from the network equipment on the second channel; and

management means adapted to repeat the message the chosen number of times and substantially simultaneously to observe the network to detect any change in the behavior of the network equipment to which the message is sent; in this case, the detected change of behavior of the network equipment may consist in receiving data from the network equipment on the second channel or a variation in a parameter chosen from, in particular, a change of operating mode, a frequency, a position, or reception of an acknowledgment following polling.

The invention further proposes a communications network controller or node equipped with a management system of the type defined hereinabove. Generally speaking, the management system is preferably installed in the portion of each network controller or other equipment responsible for controlling packet mode data transfer. In the case of a GPRS cellular radio network, this portion is the portion that supports the packet control unit (PCU) function.

The system, the network controller, and the method of the invention are suitable for any type of communications network, and in particular cellular communications networks and especially TDMA, CDMA, CDMA-One, PHS and FOMA networks.

Other features and advantages of the invention become apparent on reading the following detailed description and examining the appended drawings, in which:

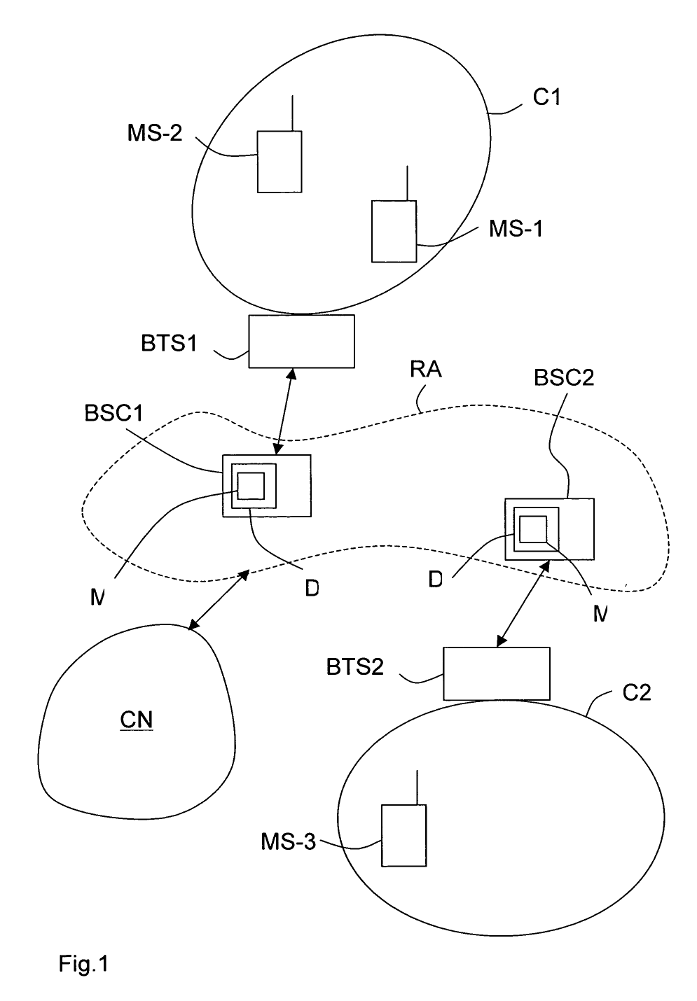

FIG. 1 shows diagrammatically a portion of a communications network with management systems of the invention installed in its network nodes or controllers, and

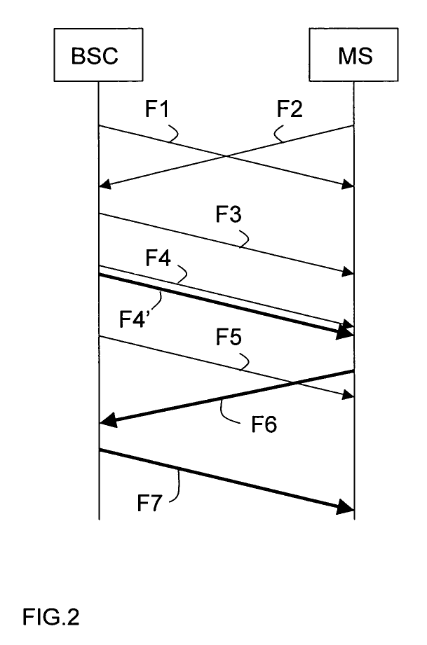

FIG. 2 shows diagrammatically the main steps of the method in accordance with the invention of changing channels or resources.

The appended drawings constitute part of the description of the invention as well as, if necessary, contributing to the definition of the invention.

The invention relates to a system and a method of managing changes of logical channels or resources between network equipments and a network. The system and the method are installed and used in communications networks, and in particular in cellular public land mobile networks (PLMN), for example 2G and 2.5G networks, such as GPRS networks, or 3G networks, such as the Universal Mobile Telecommunication System (UMTS). However, the invention is not limited to those networks and applies generally to any type of communications network.

Referring to FIG. 1, in outline, but in sufficient detail for the invention to be understood, a cellular network comprises a core network (CN) connected to a radio access network (RAN) including:

a plurality of nodes, also known as radio network controllers, connected to the core network CN via an interface; these nodes are called base station controllers (BSC) in GPRS networks and radio network controllers (RNC) in UMTS networks; and

a plurality of base stations connected individually or in groups to one of the nodes via an interface and each of which is associated with one or more cells, each of which covers a radio area; a base station is called a base transceiver station (BTS) in a GPRS network and a Node B in an UMTS network.

The following description relates to a TDMA network, to be more precise a GPRS network, by way of non-limiting example. Moreover, the network equipments are mobile stations MS-i (i=1 to 3), where applicable capable of exchanging data with other network equipments, for example in accordance with the Wireless Application Protocol (WAP), the Short Message Service (SMS), the Extended Message Service (EMS), the Multimedia Message Service (MMS), or the Transport Control Protocol (TCP). In the present context the expression “mobile station” refers to mobile telephones, personal digital assistants (PDA), or portable computers equipped with a radio interface, and more generally to any type of mobile or movable machine equipped with a radio interface and suited in particular to remote surveillance, remote maintenance, or road or rail traffic monitoring applications. However, the invention applies generally to all network equipments that can exchange data.

For the purposes of illustration, each base station BTSj (j=1 or 2) controls a single cell Cj defining a corresponding geographical area that is hereinafter treated as interchangeable with the cell Cj. Of course, the base stations could control a plurality of cells and a geographical area could be defined by a plurality of cells or portions of cells. Finally, each BSCn (n=1 or 2) controls only one BTS.

As indicated above, the system D of the invention is adapted to manage the changing of channels or resources set up between network equipments and a communications network, or to be more precise its radio access network RAN. The management system D is therefore installed in one or more equipments of the radio access network RAN, preferably in each network controller, in this example each BSC, as shown in the figures. In this case, it is preferably integrated into the portion of the network controller for controlling packet mode data transfer, in other words in the Packet Control Unit (PCU) function of each network controller in the case of a GPRS network. As a general rule, the system of the invention is preferably installed in the BSC if the latter supports the PCU function; if the BSC does not support the PCU function, the system of the invention is installed in another unit that does support the PCU function.

The management system D mainly comprises a management module M adapted to manage changes of channel (from first channels to second channels) decided on by the radio access network RAN. To be more precise, if the radio access network RAN decides that one or more network equipment(s) managed by the BSCn in which the management system D is installed must change channel or resources, the management module M instructs the BSCn to send each designated mobile station MS-i a message instructing it to continue the connection on a second or new channel C2 on its first or old channel C1.

In the case of downlink data, the management module M also instructs the base station controller BSCn to continue sending data to each designated mobile station MS-i on the first and second channels C1, C2; this is because it interrupts the sending of data on the first channel C1, maintains the sending of data on the second channel C2, and releases the resources associated with the first channel C1 as soon as it receives data or acknowledgments of data from the mobile station MS-i on the second channel C2.

If the management module M is told that a change of channel or resources must be effected, it preferably starts by determining the number of times that the BSCn must repeat the channel change message on the first channel C1 and in accordance with a chosen time scheme in order to achieve a particular required success rate, which may be variable. The required success rate for changing channels can depend on how critical the procedure is, for example in terms of resource management, or on whether it is imperative to release the original channel.

For example, the number of repetitions can be determined as a function of a required success rate and/or a measured error rate using a probability calculation which assumes, for example, that the probability of an error in a repeated message is independent of the probability of an error in the preceding message.

For example, in the case of a periodic time scheme, this presupposes a time between two repetitions that is sufficiently long, statistically speaking, for an error on sending a first message not to affect a second message. In other words, this time must be greater than the statistical average duration of a transmission error. It may be possible to deduce this period from known local conditions of the network, for example known conditions of radio propagation or of other disturbances similar to a radio transmission error, in the case of a cellular mobile radio network. However, the time can be chosen a priori.

The number of repetitions can be set in advance and remain constant for a given BSCn, of course.

If the management module M is notified that a change of channel or resources must be effected, after calculating the number of repetitions, if necessary, it preferably determines a time enabling the channel change message to reach the mobile station MS-i on the first channel C1 ahead of time, relative to activation of the channel C2, by an amount at least equal to a “time not reachable” (TNR) period that it requires to perform said change of channel or resource. Accordingly, it can be guaranteed that, with the required success rate, as explained above, the downlink data stream reaches the mobile station MS-i on the second channel C2 after the change of channel or resources message has reached the mobile station MS-i on the first channel C1 and a TNR period has elapsed after receiving that message.

Because the bit rates T1 and T2 and the propagation times D1 and D2 of the first and second channels C1 and C2 can be different, a supplementary time margin can be added to or subtracted from the above time in order to minimize the time-delay after which the equipment receives data on the second channel C2 relative to receiving data on the first channel C1 and still guarantee that no data is lost.

If the time determined is positive, the management module M instructs the BSCn to send the change of channel or resources message immediately to the designated mobile station MS-i on the first channel C1. Then, in the case of downlink data, in order to satisfy the above-mentioned time condition, it instructs it to continue sending data to the designated mobile station MS-i using the first and second channels or resources C1 and C2.

If the time determined is negative, sending of the downlink data stream on the second channel C2 should have begun already. Because this is not possible, in the case of downlink data, the management module M instructs the base station controller BSCn to start by sending the data on the second channel C2 after which the bit rate of the first channel C1 is reduced by a particular amount in order to satisfy the above-mentioned condition. The management module M then instructs the base station controller BSCn to send the change of channel or resources message to the designated mobile station MS-i on the first channel C1 after a time period (if positive) equal to D2−D1−TNR, to ensure that the change of channel or resources message is received by the mobile station MS-i ahead of time, relative to any data sent on the second channel C2, by an amount at least equal to the TNR period necessary for the mobile station MS-i to change channel. This ensures that the mobile station MS-i can reconfigure its channel or resources before it receives traffic data.

As indicated above, in either case the management module M instructs the base station controller BSCn to interrupt the first channel C1 and to maintain the second channel C2 as soon as it receives data or acknowledgments of data from the mobile station MS-i on the second channel C2.

The network resources used by the first channel C1, which were initially allocated to the mobile station MS-i by the base station controller BSCn, are then available again and can be allocated to another mobile station MS.

According to the above description, resources allocated to the first channel C1 are released when the base station controller BSC concerned receives data or acknowledgments of data from an equipment MS-i on the second channel C2.

If a base station controller BSC does not receive acknowledgments of data or messages on the second channel C2 within a predefined time of sending a first message to an equipment MS-i, the resources remain allocated to the first channel C1. In this case, once the predefined time has elapsed, the management module M (and therefore the base station controller BSC) must sent the same message to the network equipment again at least once.

Now, as mentioned in the introduction, a message or a command sent to an equipment, in this instance a mobile station MS-i, may not reach it. Moreover, because the network error rate is non-zero, an equipment MS-i may send an acknowledgment of a message that does not reach the base station controller BSC.

The predefined time between sending a first message and sending the next message increases in direct proportion to the network error rate. Consequently, the higher the network error rate, the more uplink resources and time are consumed by the mechanism for managing acknowledgments, and this can degrade the quality of service offered to network users or customers.

To remedy this drawback, the invention therefore proposes replacing the mechanism for managing acknowledgments by a mechanism for detecting changes of behavior of the equipment MS-i. For example, the mechanism can detect sending of data on the channel C2, as mentioned above.

The management module M of the system D can be adapted accordingly.

In this case, the management module M is preferably adapted to determine how many times the base station controller BSC is authorized to repeat the sending of a message or command as a function of the average error rate on the channel that the messages must take and given a required success rate.

The average error rate can either be determined by the management module M, for example from measurements supplied by the base station controller BSC and carried out by the network, such as error rate measurements, or supplied to the management module M by the network operator.

Moreover, the success rate can either be supplied to the management module M by the operator or estimated by the management module M on the basis of one or more chosen network parameters.

In the present context, the term “parameter” refers both to configurable parameters supplied by the operator and to measurements effected within the network. Thus a parameter can be, for example, a change of operating mode parameter (resulting from the sending of radio measurements on adjacent cells of the network), a frequency, a position (obtained following a location request), or reception of an acknowledgment following polling.

Once the number of repetitions has been determined, the management module M must determine the waiting time between two repeated messages, which can be constant or variable.

In the case of a constant waiting time, i.e. in the case of periodic repetition, the repetition period is chosen to guarantee that errors are uncorrelated or virtually uncorrelated, for example. In other words, the repetition period is chosen to prevent correlation between the error rates associated with two messages received consecutively. As indicated above, this presupposes a time between two repetitions that is sufficiently long, statistically speaking, for an error on sending a first message not to affect a second message. It may be possible to deduce this time from known local conditions of the network, for example known conditions of radio propagation or of other disturbances similar to a radio error, in the case of a cellular radio network. However, the time can equally well be chosen a priori.

Once all this information relating to the repletion of the message has been determined, the management module M can send a message or command to an equipment MS-i and then repeat it N times in accordance with the information received, without waiting for the equipment MS-i to send it an acknowledgment. At the same time, the management module M observes the network in order to determine any change in the behavior of the equipment MS-i.

If the equipment MS-i has received and obeyed one of the messages, its behavior changes, whereas its behavior remains unchanged if the equipment MS-i has not received any of the N messages. It is considered here that the equipment MS-i ignores repeated messages reaching it that correspond to the configuration that it set up following the reception of a preceding identical message.

A detected change of behavior can in particular be reception of data from the equipment MS-i concerned on the channel C2. However, the detected change may equally well be a variation in the value of a parameter of the network relative to the connection to the equipment MS-i, as indicated above.

The management module M interprets any change of behavior of an equipment MS-i following the sending of a series of N repeated messages as an acknowledgment of those messages. On the other hand, if there is no change in the behavior of an equipment MS-i following the sending of a series of N repeated messages, the management module M knows that the equipment has not received the messages. Depending on its configuration, the management module can then either attempt to send N repeated messages to the equipment MS-I again or to initiate appropriate action, for example incrementing by one unit an internal counter for reporting a series of failures to the operator.

This mode of operation is particularly advantageous because it avoids consuming resources in the uplink direction (from the equipment to the network) for transmitting acknowledgments.

Furthermore, in terms of the ratio between the success rate and the time taken for the behavior of an equipment to change, this procedure is more efficient than the conventional procedure involving receiving acknowledgments. This is particularly beneficial in wireless networks, in which the error rate can be high and the time necessary to make the change can be relatively long.

The management module M of the system D of the invention can be implemented in the form of data processing modules (software) or, at least in part, in the form of electronic circuits (hardware), or in the form of combinations of software and hardware.

The main steps of a method in accordance with the invention of changing channel or resources, which can be executed by the management system D described above, for example, are summarized next with reference to FIG. 2, in which narrow arrows represent a connection on the first channel C1 and wide arrows represent a connection on the second channel C2.

A mobile station MS in a cell Cj controlled by a base station BTSj managed by a base station controller BSC has set up a connection on the first channel C1 to a communications network, to be more precise to said base station controller BSC of that network. The connection on the channel C1 enables the exchange of data or downlink and uplink traffic.

When the radio access network RAN has decided to change channel or resources and the system D has sent instructions to the base station controller BSC, the latter sends the change of channel or resources message to the mobile station MS on the first channel C1 (arrow F3) and then sends traffic data to the mobile station MS on the first and second channels C1 and C2 (arrows F4 and F4′). As it has not yet received data from the mobile station MS on the second channel C2, the base station controller BSC repeats the change of channel or resources message on the first channel C1 (arrow F5). In this example, the mobile station MS receives the first change of channel or resources message and is reconfigured to use the second channel C2 shortly after the base station controller BSC repeats its second message. Thus the mobile station MS starts to send data or acknowledgments of data to the base station controller BSC on the second channel C2 before the second message reaches it (arrow F6).

The data sent by the mobile station MS reaches the base station controller BSC before it has repeated the message again. Consequently, on receiving data on the second channel C2, the base station controller BSC interrupts the sending of traffic data on the first channel C1 and maintains it on the second channel C2 (arrow F7), which completes the change of channel or resources procedure.

The invention can be applied to any type of change of channel or resources, independently of the capacities of the channels or resources, the time-delays that they introduce, and the underlying technologies. The invention can therefore be applied to changing channels or resources between communications networks supporting different technologies, for example between 2G and 4G networks or between a 3G network and a Bluetooth connection. It can equally well be applied to any type of change of logical channels, and in particular to changing radio resources in a GSM/GPRS network and channel codes in a UMTS/UTRAN network.

Furthermore, the invention optimizes changing the channel or resources used by each network equipment by offering, firstly, a minimum but guaranteed period of overlapping use of the first and second channels, secondly, a guaranteed success rate for the change of channel or resources, and, thirdly, minimum consumption of bandwidth.

Moreover, the invention reduces, at least statistically, the duration of the change of channel or resources procedure and the variations in that duration.

Finally, the invention limits the consumption of uplink resources.

The invention is not limited to the embodiments of a system, a network equipment, a base station, a network controller, and a method described hereinabove by way of example only, and encompasses all variants thereof within the scope of the following claims that the person skilled in the art might envisage.

Thus an example of a management system installed in a network controller to manage changes of channel on which it has decided has been described. However, the system could be installed in other equipment, for example in a router to optimize the changing of routes.

Moreover, an application of the invention to cellular communications networks has been described, but the invention is not limited to this type of network, and applies to any type of communications network in which connections set up between network equipment and the network are subject to a non-zero transmission error rate.

1. A method of managing the changing of channels between a communications network and at least one network equipment (MS-i), characterized in that after setting up a connection for sending and/or receiving data on a first channel (C1) between said network and said network equipment (MS-i), said network equipment (MS-i) is sent a message on said first channel (C1) instructing it to continue said connection on a second channel (C2) and to maintain said first channel (C1) until it receives data and/or acknowledgments of data from said equipment (MS-i) on said second channel (C2), whereupon the resources associated with said first channel (C1) are released.

2. A method according to claim 1, characterized in that, in the case of sending data to the equipment (MS-i), the sending of the data to said network equipment (MS-i) on said first channel (C1) and said second channel (C2) continues until data and/or acknowledgments of data are received from said network equipment (MS-i) on said second channel (C2).

3. A method according to claim 1, characterized in that said message is repeated on said first channel (C1) a chosen number of times in accordance with a chosen time scheme.

4. A method according to claim 3, characterized in that the number of repetitions is chosen as a function of a required success rate and/or a measured error rate.

5. A method according to claim 3, characterized in that said time scheme is a periodic scheme.

6. A method according to claim 5, characterized in that the message repetition period is chosen to prevent correlation between error rates associated with two consecutive messages.

7. A method according to claim 1, characterized in that a time is determined that enables channel change messages to reach said network equipment (MS-i) ahead of time by an amount at least equal to the time necessary for the network equipment (MS-i) to change channel, and the sending of data on said first channel (C1) and said second channel (C2) is deferred by an amount that is a function of said time.

8. A method according to claim 7, characterized in that said time is also a function of the data bit rates and/or data sending speeds of said first channel (C1) and said second channel (C2).

9. A method according to claim 3, characterized in that the message is repeated said chosen number of times until acknowledgments of data are received from said network equipment (MS-i) on said second channel (C2).

10. A method according to claim 3, characterized in that the message is repeated said chosen number of time periods whilst observing said network to detect any change of behavior of the network equipment (MS-i) to which said message is sent.

11. A method according to claim 10, characterized in that the detected change of behavior of the network equipment (MS-i) consists in receiving data from said network equipment (MS-i) on said second channel (C2).

12. A method according to claim 10, characterized in that a detected change of behavior of the network equipment (MS-i) consists in detecting variation in a parameter chosen in a group comprising at least a change of mode of operation parameter, a frequency, a position, and reception of acknowledgments.

13. A system (D) for managing the changing of channels between a network controller (BSCn) and at least one network equipment (MS-i) in a communications network, which system is characterized in that it includes management means (M) adapted, in the event of setting up a connection for sending and/or receiving data on a first channel (C1) between said network controller (BSCn) and said network equipment (MS-i), to request said network controller (BSCn): i) to send said network equipment (MS-i) a message on said first channel (C1) instructing it to continue said connection on a second channel (C2) and to maintain said first channel (C1) until it receives data and/or acknowledgments of data from said equipment (MS-i) on said second channel (C2), and ii) to release the resources associated with said first channel (C1) on receiving said data and/or said acknowledgments of data.

14. A system according to claim 13, characterized in that, in the case of sending data to the equipment (MS-i), said management means(M) are adapted to request said network controller (BSCn) to continue to send data to said network equipment (MS-i) on said first channel (C1) and said second channel (C2) until it receives data and/or acknowledgments of data from said network equipment (MS-i) on said second channel (C2).

15. A system according to claim 13, characterized in that said management means (M) are adapted to repeat said message on said first channel (C1) a chosen number of times in accordance with a chosen time scheme.

16. A system according to claim 15, characterized in that said management means (M) are adapted to choose the number of repetitions as a function of a required success rate and/or a measured error rate.

17. A system according to claim 15, characterized in that said time scheme is a periodic scheme.

18. A system according to claim 17, characterized in that said management means (M) are adapted to determine the message repetition period to prevent correlation between error rates associated with two consecutive messages.

19. A system according to claim 13, characterized in that said management means (M) are adapted to determine a time enabling change of channel messages to reach said network equipment (MS-i) ahead of time by an amount at least equal to the time necessary for the network equipment (MS-i) to change channel and then to instruct said network controller (BSCn) to defer the sending of data on said first channel (C1) and said second channel (C2) by an amount that is a function of said time.

20. A system according to claim 19, characterized in that said management means (M) are adapted to determine said time also as a function of data bit rates and/or data sending speeds of said first channel (C1) and said second channel (C2).

21. A system according to claim 15, characterized in that said management means (M) are adapted to repeat the message said chosen number of times until they receive acknowledgments of data from said network equipment (MS-i) on said second channel (C2).

22. A system according to claim 15, characterized in that said management means (M) are adapted to repeat the message said chosen number of times and substantially simultaneously to observe said network to detect any change of behavior of the network equipment (MS-i) to which said message is sent.

23. A system according to claim 22, characterized in that said management means (M) detect a change of behavior of the network equipment (MS-i) in the event of receiving data from said network equipment (MS-i) on said second channel (C2).

24. A system according to claim 22, characterized in that said management means (M) detect a change of behavior of the network equipment (MS-i) in the event of variation of a parameter chosen in a group comprising at least a change of mode of operation parameter, a frequency, a position, and reception of acknowledgments.

25. A network controller (BSCn) of an access network (RAN) of a communications network, characterized in that it includes a system (D) according to claim 13.

26. Equipment of an access network (RAN) of a communications network including at least one network controller (BSCn), characterized in that it includes a system (D) according to claim 13.

27. A communications network including an access network (RAN) including at least one network controller (BSCn), characterized in that it includes at least one system (D) according to claim 13.

28. Use of the system (D), the method, the network controller (BSCn), and the access network equipment (RAN) according to claim 1 in cellular communications networks.

29. Use according to claim 28 in cellular communications networks chosen in a group comprising TDMA, CDMA, CDMA-One, PHS and FOMA networks.
